(19) United States
(12) Patent Application Publication
(10) Pub. No.: US 2026/0361118 A1
(43) Pub. Date: Nov. 12, 2026

(54) POWER SUPPLY CIRCUIT FOR ENERGY STORAGE POWER SUPPLY AND ENERGY STORAGE POWER SUPPLY

(71) Applicant: SHENZHEN HELLO TECH ENERGY CO., LTD, Shenzhen (CN)

(72) Inventors: Gaosong SHEN, Shenzhen (CN); Feiyan LUO, Shenzhen (CN)

(21) Appl. No.: 19/736,992

(22) Filed: Jul. 10, 2026

(30) Foreign Application Priority Data
Apr. 1, 2026 (CN) 202610427554.2
Apr. 1, 2026 (CN) 202620429874.7

(51) Int. Cl. H02J 9/06

(52) U.S. Cl. CPC H02J 9/063; H02J 9/068; H02J 2207/20

(57) ABSTRACT

Provided are a power supply circuit and an energy storage power supply. The power supply circuit includes an alternating current input terminal, an alternating current output terminal, an inverter, and a grounding circuit. A live connection terminal of the inverter is electrically connected to a first live terminal of the alternating current input terminal through a first live branch and a second live terminal of the alternating current output terminal through a second live branch. A neutral connection terminal of the inverter is electrically connected to a first neutral terminal of the alternating current input terminal through a first neutral branch and a second neutral terminal of the alternating current output terminal through a second neutral branch. The grounding circuit is electrically connected to the first neutral branch and a second ground terminal of the alternating current output terminal, and is configured to selectively establish a short-circuit connection therebetween.

### CROSS-REFERENCE TO RELATED APPLICATIONS

This application claims priorities and benefits of Chinese Patent Applications No. 202610427554.2 and No. 202620429874.7, filed with China National Intellectual Property Administration on Apr. 1, 2026, the entire contents of which are incorporated herein by reference.

### FIELD

The present disclosure relates to the field of energy storage technologies, and in particular, to a power supply circuit for an energy storage power supply and an energy storage power supply.

### BACKGROUND

Currently, an energy storage power supply may operate as an independent power supply for off-grid discharge when utility power is unavailable. An alternating current output terminal of the energy storage power supply generally employs a floating ground system, i.e., there is no effective electrical connection between a neutral line (N) and a protection earth line (PE) of an output socket. However, many existing electrical loads, such as an inverter air conditioner, a vehicle charging pile, and an instantaneous water heater, typically integrate grounding detection modules internally. These loads require grounding detection prior to startup and can only operate normally when properly grounded. When powered by the energy storage power supply, such loads fail to pass a grounding self-test, resulting in frequent device errors, failure to start, or refusal to operate, which severely affects user experience and compatibility of an energy storage device.

### SUMMARY

Embodiments of the present disclosure provide a power supply circuit for an energy storage power supply and an energy storage power supply.

The power supply circuit for the energy storage power supply according to embodiments of the present disclosure includes: an alternating current input terminal configured to be supplied with an external alternating current, in which the alternating current input terminal includes a first live terminal, a first neutral terminal, and a first ground terminal; an alternating current output terminal configured to output the external alternating current, in which the alternating current output terminal includes a second live terminal, a second neutral terminal, and a second ground terminal; an inverter having a live connection terminal and a neutral connection terminal, in which the live connection terminal is electrically connected to the first live terminal through a first live branch, in which the neutral connection terminal is electrically connected to the first neutral terminal through a first neutral branch, in which the live connection terminal is electrically connected to the second live terminal through a second live branch, and in which the neutral connection terminal is electrically connected to the second neutral terminal through a second neutral branch; and a grounding circuit electrically connected to the first neutral branch and the second ground terminal. The grounding circuit is configured to selectively establish a short-circuit connection between the first neutral branch and the second ground terminal.

In the power supply circuit for the energy storage power supply of the present disclosure, a neutral line may be in a short-circuit connection with a ground line through the grounding circuit. In this way, when the energy storage power supply is used to supply power to an electrical load that first requires grounding detection, the electrical load can smoothly pass a grounding self-test, which prevents the electrical load from failing to operate normally due to the failure to perform the grounding detection. Therefore, applicability of the energy storage power supply can be improved, and user's usage requirements are satisfied.

In some embodiments, the grounding circuit includes: a wire, in which two ends of the wire are connected to the first neutral branch and the second ground terminal, respectively; a resistor element connected in series between the first neutral branch and a ground line; and a grounding switch connected between the first neutral branch and the ground line and configured to control connection and disconnection of the grounding circuit.

In the above embodiments, the manner of controlling the connection and disconnection of the grounding circuit by the grounding switch is simple and reliable. The circuit is protected by the resistor element while the grounding detection of the electrical load is satisfied.

In some embodiments, the first live branch is provided with a first switch, and the first neutral branch is provided with a second switch configured to control connection and disconnection of the alternating current input terminal for inputting the alternating current.

In the above embodiments, input interruption of the alternating current can be controlled by opening the first switch or the second switch, providing a reliable and simple control manner.

In some embodiments, the grounding circuit is electrically connected to the first neutral branch between the second switch and the neutral connection terminal.

In some embodiments, the grounding circuit is electrically connected to the first neutral branch between the second switch and the first neutral terminal.

In some embodiments, the first neutral branch is further provided with a third switch disposed closer to the neutral connection terminal than the second switch. The grounding circuit is electrically connected to the first neutral branch between the second switch and the third switch.

In some embodiments, the second live branch is provided with a fourth switch, and the second neutral branch is provided with a fifth switch. A first end of the first switch is connected to the first live terminal, a second end of the first switch is connected to a first end of the fourth switch, and a second end of the fourth switch is connected to an output socket. A second end of the second switch is connected to a first end of the fifth switch, and a second end of the fifth switch is connected to the output socket. When utility power is available, each of the first switch, the second switch, the fourth switch, and the fifth switch is closed, and the grounding circuit is in an open-circuit state, enabling power to be supplied to an electrical load. When the utility power fails, the first switch and the second switch are opened, and the fourth switch and the fifth switch are closed, enabling the energy storage power supply to supply power to the electrical load and the grounding circuit to be switched into a connection state.

In the above embodiments, through control on the first switch, the second switch, the fourth switch, the fifth switch, and the grounding switch, rapid switching between utility power supply and the energy storage power supply can be achieved, and the grounding circuit can be flexibly controlled to satisfy grounding detection requirements when the utility power fails.

In some embodiments, the live connection terminal of the inverter is connected between the second end of the first switch and the first end of the fourth switch, and the neutral connection terminal of the inverter is connected between the second end of the second switch and the first end of the fifth switch.

In the above embodiments, the live connection terminal of the inverter is disposed between the first switch and the fourth switch, and the neutral connection terminal is disposed between the second switch and the fifth switch, ensuring that the power supply circuit has a compact structure and a reliable electrical connection.

In some embodiments, the second live branch is provided with a fourth switch, and the second neutral branch is provided with a fifth switch. A first end of the first switch is connected to the first live terminal, a second end of the first switch is connected to a first end of the fourth switch, and a second end of the fourth switch is connected to an output socket. A first end of the second switch is connected to the first neutral terminal, a second end of the second switch is connected to a first end of the fifth switch, and a second end of the fifth switch is connected to the output socket. When utility power is available, each of the first switch, the second switch, the fourth switch, and the fifth switch is closed, and the grounding circuit is in an open-circuit state, enabling power to be supplied to an electrical load. When the utility power fails, the first switch and the second switch are opened, and the fourth switch and the fifth switch are closed, enabling the energy storage power supply to supply power to the electrical load and the grounding circuit to be switched into a connection state.

In the above embodiments, through the control on the first switch, the fourth switch, the second switch, the fifth switch, and the grounding switch, the rapid switching between the utility power supply and the energy storage power supply can be achieved, and the grounding circuit can be flexibly controlled to satisfy the grounding detection requirements when the utility power fails.

In some embodiments, the live connection terminal of the inverter is connected between the second end of the first switch and the first end of the fourth switch, and the neutral connection terminal of the inverter is connected between the second end of the second switch and the first end of the fifth switch.

In the above embodiments, the first end of the inverter is connected between the first switch and the fourth switch, and the second end of the inverter is connected between the second switch and the fifth switch, ensuring that the power supply circuit has a compact structure and a reliable electrical connection.

In some embodiments, the second live branch is provided with a fourth switch, and the second neutral branch is provided with a fifth switch. A first end of the third switch is connected to a second end of the second switch, and a second end of the third switch is connected to a first end of the fifth switch. The neutral connection terminal of the inverter is connected between the second end of the third switch and the first end of the fifth switch. When utility power is available, each of the first switch, the second switch, the third switch, the fourth switch, and the fifth switch is closed, and the grounding circuit is in an open-circuit state, enabling power to be supplied to an electrical load. When the utility power fails, the first switch and the second switch are opened, and the third switch, the fourth switch, and the fifth switch are closed, enabling the energy storage power supply to supply power to the electrical load and the grounding circuit to be switched into a connection state.

In the above embodiments, when it is necessary to disconnect the grounding circuit, simply opening one of the third switch and the fifth switch is sufficient. In this way, when a failure occurs in one of the third switch and the fifth switch, the grounding circuit can still be disconnected by the other one of the third switch and the fifth switch, further ensuring reliability of the power supply circuit.

In some embodiments, the live connection terminal of the inverter is connected between a second end of the first switch and a first end of the fourth switch, and the neutral connection terminal of the inverter is connected between the second end of the third switch and the first end of the fifth switch.

In the above embodiments, the live connection terminal of the inverter is disposed between the first switch and the fourth switch, and the neutral connection terminal is disposed between the third switch and the fifth switch, ensuring that the power supply circuit has a compact structure and a reliable electrical connection.

In some embodiments, the second live branch is provided with a fourth switch, and the second neutral branch is provided with a fifth switch. The power supply circuit further includes a detection unit configured to detect a current of the second live branch and a current of the second neutral branch. When a difference between the current of the second live branch and the current of the second neutral branch is greater than a predetermined threshold, the fourth switch and the fifth switch are opened or the inverter stops operating.

In the above embodiments, the detection unit implements balance detection of the power supply circuit between the output socket and the electrical load, ensuring that a leakage protection circuit can operate stably, accurately, and rapidly under different power supply modes including the power supply from the utility power and the power supply from the energy storage power supply.

In some embodiments, the power supply circuit further includes an analog circuit including a detection resistor and a detection switch. A first end of the detection resistor is connected to the second neutral branch, a second end of the detection resistor is connected to a first end of the detection switch, and a second end of the detection switch is connected to the second live branch. When the detection switch is closed, the current of the second live branch is partially shunted to the analog circuit, enabling the difference between the current of the second live branch and the current of the second neutral branch to be greater than the predetermined threshold to verify effectiveness of the detection unit.

In the above embodiments, the analog circuit can verify effectiveness of a controller at any time, which can timely detect a relevant fault to ensure long-term effective operation of the controller and protect long-term safety of the circuit. Effectiveness of a control assembly can be verified at any time through opening and closing of the detection switch, providing a simple operation method and a reliable and easily implementable detection manner.

Embodiments of the present disclosure further provide an energy storage power supply. The energy storage power supply includes the power supply circuit according to any of the above embodiments and a battery module electrically connected to the inverter.

Additional aspects and advantages of the present disclosure will be in part set forth below, become apparent in part from the following description, or can be learned by practice of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings, in which:

FIG. 1 is a schematic circuit diagram of an energy storage power supply according to an embodiment of the present disclosure;

FIG. 2 is a schematic circuit diagram of an energy storage power supply according to another embodiment of the present disclosure;

FIG. 3 is a schematic circuit diagram of an energy storage power supply according to yet another embodiment of the present disclosure; and

FIG. 4 is a schematic circuit diagram of an energy storage power supply according to still another embodiment of the present disclosure.

Reference numerals in the drawings are described below.
100—energy storage power supply, 10—battery module, 20—inverter, 21—live connection terminal, 22—neutral connection terminal, 30—grounding circuit, 31—resistor element, 32—grounding switch, 33—wire, 40—live line, 41—first live branch, 42—second live branch, 50—neutral line, 51—first neutral branch, 52—second neutral branch, 60—ground line, 70—switching switch, 71—first switch, 72—second switch, 73—third switch, 74—fourth switch, 75—fifth switch, 80—output socket, 200—power supply circuit, 210—leakage protection circuit, 211—connection switch, 212—control assembly, 2121—detection unit, 2122—controller, 213—analog circuit, 2131—detection resistor, 2132—detection switch, 214—power supply, 220—alternating current input terminal, 221—first live terminal, 222—first neutral terminal, 223—first ground terminal, 230—alternating current output terminal, 231—second live terminal, 232—second neutral terminal, 233—second ground terminal, 300—electrical load.

### DETAILED DESCRIPTION

Embodiments of the present disclosure will be described in detail below, and examples of the embodiments are shown in the accompanying drawings, in which identical or similar reference signs denote identical or similar elements or elements with identical or similar functions through the accompanying drawings. The following embodiments described with reference to the drawings are illustrative and intended to explain the present disclosure, rather than being interpreted as limitations on the present disclosure.

In the description of the present disclosure, it should be understood that, the orientation or the position indicated by terms such as “center”, “longitudinal”, “lateral”, “length”, “width”, “thickness”, “over”, “below”, “front”, “rear”, “left”, “right”, “vertical”, “horizontal”, “top”, “bottom”, “inner”, “outer”, “clockwise”, and “anti-clockwise” should be construed to refer to the orientation and the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure. In addition, the terms “first” and “second” are used only for description and shall not be interpreted as an indication or implication of relative importance or an implicit indication of the number of technical features. Thus, features associated with “first” and “second” may include at least one or more such features, either explicitly or implicitly. In the description of the present disclosure, “a plurality of” means two or more, unless otherwise specifically defined.

In the present disclosure, it should be noted that, unless otherwise clearly specified and limited, terms such as “install”, “connect”, “couple”, and the like should be understood in a broad sense. For example, it may be a fixed connection or a detachable connection or a connection as one piece; a mechanical connection or an electrical connection or mutual communication; a direct connection or an indirect connection through an intermediate; or internal communication of two components or the interaction relationship between two components. For those of ordinary skill in the art, the specific meaning of the above terms in the present disclosure should be understood according to specific circumstances.

In the present disclosure, unless expressly stipulated and defined otherwise, the first feature “on” or “under” the second feature may include that the first feature is in direct contact with the second feature, or further include that the first and second features are in indirect contact through another feature between the first and second features. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

Various embodiments or examples for implementing different structures of the present disclosure are provided below. In order to simplify the description of the present disclosure, components and configurations of specific examples are described below. These specific examples are merely for the purpose of illustration, rather than limiting the present disclosure. Further, the same reference numerals and/or reference letters may appear in different examples of the present disclosure for the purpose of simplicity and clarity, instead of indicating a relationship between different embodiments and/or the discussed configurations. In addition, the present disclosure provides examples of various specific processes and materials. However, applications of other processes and/or the use of other materials are conceivable for those of ordinary skill in the art.

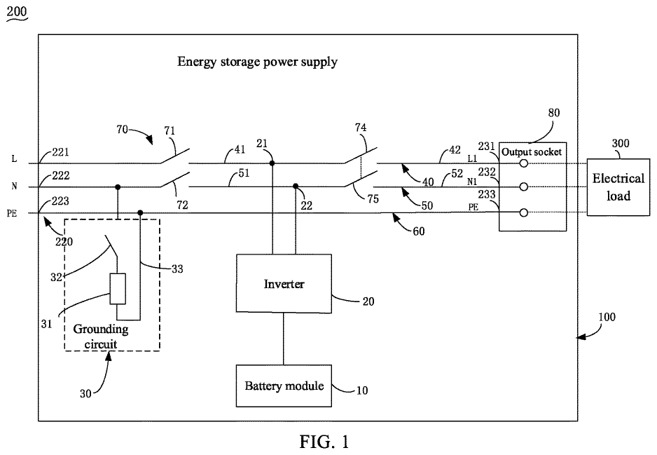

FIG. 1 is a schematic circuit diagram of an energy storage power supply 100 according to an embodiment of the present disclosure. A power supply circuit 200 for the energy storage power supply 100 according to the embodiments of the present disclosure includes an alternating current input terminal 220, an alternating current output terminal 230, an inverter 20, and a grounding circuit 30. The alternating current input terminal 220 is configured to be supplied with an external alternating current, and includes a first live terminal 221, a first neutral terminal 222, and a first ground terminal 223. The alternating current output terminal 230 is configured to output the external alternating current, and includes a second live terminal 231, a second neutral terminal 232, and a second ground terminal 233. The inverter 20 has a live connection terminal 21 and a neutral connection terminal 22. The live connection terminal 21 is electrically connected to the first live terminal 221 through a first live branch 41, and the neutral connection terminal 22 is electrically connected to the first neutral terminal 222 through a first neutral branch 51. The live connection terminal 21 is electrically connected to the second live terminal 231 through a second live branch 42, and the neutral connection terminal 22 is electrically connected to the second neutral terminal 232 through a second neutral branch 52. The grounding circuit 30 is electrically connected to the first neutral branch 51 and the second ground terminal 233. The grounding circuit 30 is configured to selectively establish a short-circuit connection between the first neutral branch 51 and the second ground terminal 233.

In the power supply circuit 200 for the energy storage power supply 100 of the present disclosure, a neutral line 50 can be in a short-circuit connection with a ground line 60 through the grounding circuit 30. In this way, when the energy storage power supply 100 is used to supply power to an electrical load 300 that first requires grounding detection, the electrical load 300 can smoothly pass a grounding self-test, which prevents the electrical load 300 from failing to operate normally due to the failure to perform the grounding detection. Therefore, applicability of the energy storage power supply 100 can be improved, and user's usage requirements are satisfied.

In an exemplary embodiment of the present disclosure, the battery module 10 is a module of the energy storage power supply 100 for implementing storage and release of electric energy. The inverter 20 of the energy storage power supply 100 is a power electronic conversion device configured to implement mutual conversion between a direct current and an alternating current. The inverter 20 may be a bidirectional inverter 20. When utility power is available, the inverter 20 is in a rectification mode to convert a alternating current from the utility power into a direct current for charging the battery module 10. When the utility power fails, the inverter 20 is in an inversion mode to convert the direct current outputted by the battery module 10 into an alternating current at a standard operating frequency for supplying power to the electrical load 300. The electrical connection involved in the embodiments of the present disclosure may be a direct electrical connection or an electrical connection through an intermediate conductor.

The grounding circuit 30 for the energy storage power supply 100 is a selectively connected electrical branch having two ends connected to the neutral line 50 and the ground line 60, respectively. When the utility power is available, the grounding circuit 30 is in an open-circuit state, the electrical load 300 is powered by the utility power, and the battery module 10 is charged by the utility power. When the utility power fails, the electrical load 300 is powered by the battery module 10. When an electrical load 300, such as a device integrating a leakage protector, an insulation monitoring module, or a grounding detection circuit internally (e.g., a medical device or a vehicle charging pile), that requires a ground connection to the neutral line 50 and the ground line 60 is connected, the grounding circuit 30 can be connected at this time. The grounding circuit 30 establishes the same connection between the neutral line 50 and the ground line 60 as in a case of a utility power supply by connecting to the neutral line 50 and the ground line 60, simulating a grounding condition of a power grid. A grounding detection circuit, a leakage detection circuit, and an insulation monitoring circuit inside the electrical load 300 are used to identify a standard-compliant grounding state, to satisfy detection requirements of the load, ensure normal startup and stable operation of the electrical load 300, and satisfy relevant usage requirements, greatly improving an application range and practicality of the energy storage power supply 100.

Referring to FIG. 1, in some embodiments, the grounding circuit 30 includes a resistor element 31, a grounding switch 32, and a wire 33. Two ends of the wire 33 are connected to the first neutral branch 51 and the second ground terminal 233, respectively. A first end of the resistor element 31 is connected to the ground line 60, and a second end of the resistor element 31 is connected to a first end of the grounding switch 32. A second end of the grounding switch 32 is connected to the neutral line 50. When the grounding switch 32 is closed, the neutral line 50 is in a short-circuit connection with the ground line 60.

In the above embodiments, the manner of controlling connection and disconnection of the grounding circuit 30 by the grounding switch 32 is simple and reliable. The circuit is protected by the resistor element 31 while the grounding detection of the electrical load 300 is satisfied.

In an exemplary embodiment of the present disclosure, the resistor element 31 is a current-limiting device that is disposed in the grounding circuit 30 and has a constant resistance value. The resistor element 31 is capable of allowing a current to flow through the grounding circuit 30. In this way, an excessive current is prevented from being generated due to a direct short-circuit connection between the neutral line 50 and the ground line 60, avoiding triggering overcurrent protection, damaging components, or causing safety hazards. Under the premise of satisfying electrical connection requirements for grounding detection, a safe connection between the neutral line 50 and the ground line 60 is achieved, ensuring that an analog circuit 213 of the load normally identifies the grounding state. The grounding switch 32 is a controllable switching device, such as a relay, an electronic switch, or a mechanical switch. The grounding switch 32 and the resistor element 31 are connected in series in the grounding circuit 30, with an end connected to the neutral line 50 and another end connected to the resistor element 31, for controlling the connection and disconnection of the grounding circuit 30.

When the utility power is available, the grounding switch 32 remains opened, the grounding circuit 30 does not operate, and the electrical load 300 is powered by the utility power. When the utility power fails, the inverter 20 is in the inversion mode, the battery module 10 supplies power to the electrical load 300, and the grounding switch 32 is closed. The grounding circuit 30 is connected between the neutral line 50 and the ground line 60, which can satisfy grounding detection requirements of the electrical load 300. In this way, when power is supplied to the electrical load 300 from the energy storage power supply 100, a user may choose whether to connect the grounding circuit 30 based on a type of the connected electrical load 300, improving the applicability of the energy storage power supply 100. Exemplarily, the user may manually operate the switch, or remotely control the closing and opening of the switch. The grounding switch 32 can control the connection and disconnection of the grounding circuit 30 in real time as desired, providing a simple and reliable control manner that can quickly respond to the grounding detection requirements of the electrical load 300.

Referring to FIG. 1, in some embodiments, the energy storage power supply 100 further includes a switching switch 70 configured to connect the first live terminal 221 to the output socket of the energy storage power supply 100 when the utility power is available, and to connect the battery module 10 and the output socket when the utility power fails.

In the above embodiments, switching between the utility power supply and the energy storage power supply 100 for the electrical load 300 is performed by the switching switch 70. The operation manner is simple and reliable, and a power supply mode of the electrical load 300 can be quickly switched flexibly based on a usage scenario. Therefore, a continuous power supply to the electrical load 300 is ensured.

In an exemplary embodiment of the present disclosure, the switching switch 70 is an electrical switching device disposed between the first live terminal 221 and the output socket of the energy storage power supply 100. The switching switch 70 is configured to control the storage and release of electrical energy by the battery module 10 of the energy storage power supply 100, and to achieve the switching between the utility power supply and the energy storage power supply 100. When the utility power is available, the switching switch 70 is closed to connect a utility power path, directly transmitting the utility power to the output socket of the energy storage power supply 100 to supply power to the load. When the utility power fails, the switching switch 70 disconnects the utility power path and connects an inversion output path of the battery module 10, enabling the battery module 10 to supply power to the load through the inverter 20.

Meanwhile, the switching switch 70 can isolate a utility power supply circuit from a power supply circuit of the energy storage power supply 100, ensuring that output of the utility power and output of the battery module 10 are not simultaneously connected to the output socket of the energy storage power supply 100, effectively preventing a case where power is supplied to the electrical load 300 simultaneously from both the utility power and the energy storage power supply 100 at the moment when the utility power recovers after a failure, and improving electrical safety of the system. Moreover, when the utility power fails, switching from a utility power supply mode to a power supply mode of the energy storage power supply 100 is quickly completed by the switching switch 70, enabling the output socket of the energy storage power supply 100 to obtain an uninterrupted and stable alternating current supply.

Referring to FIG. 1, in some embodiments, the switching switch 70 includes a first switch 71, a second switch 72, a fourth switch 74, and a fifth switch 75. The first switch 71 and the fourth switch 74 are both disposed on a live line 40. The second switch 72 and the fifth switch 75 are both disposed on the neutral line 50. A first end of the first switch 71 is connected to the first live terminal 221, and a second end of the first switch 71 is connected to a first end of the fourth switch 74. A second end of the fourth switch 74 is connected to the output socket. A first end of the second switch 72 is connected to a first end of the grounding circuit 30, and a second end of the second switch 72 is connected to a first end of the fifth switch 75. A second end of the fifth switch 75 is connected to the output socket 80. A second end of the grounding circuit 30 is connected to the ground line 60. When the utility power is available, each of the first switch 71, the fourth switch 74, the second switch 72, and the fifth switch 75 is closed, and the grounding circuit 30 is in an open-circuit state, enabling power to be supplied to the battery module 10 and the electrical load 300. When the utility power fails, the first switch 71 and the second switch 72 are opened, and the fourth switch 74 and the fifth switch 75 are closed, enabling the battery module 10 to supply power to the electrical load 300 and the grounding circuit 30 to be switched into a connection state.

In the above embodiments, through control on the first switch 71, the second switch 72, the fourth switch 74, the fifth switch 75, and the grounding switch 32, rapid switching between the utility power supply and the energy storage power supply 100 can be achieved, and the grounding circuit 30 can be flexibly controlled to satisfy the grounding detection requirements when the utility power fails.

In an exemplary embodiment of the present disclosure, the first switch 71 is disposed on the first live branch 41 and is connected to the live connection terminal 21 of the inverter 20. The first end of the first switch 71 is an end of the first switch 71 connected to the first live terminal 221. The fourth switch 74 is a switching device connected in series between the live connection terminal 21 of the inverter 20 and the live line 40 of the output socket 80 of the energy storage power supply 100. The second switch 72 and the fifth switch 75 are switching devices disposed on the first neutral branch 51 and the second neutral branch 52. When the utility power is available, the grounding circuit 30 is in the open-circuit state, and the grounding circuit 30 does not affect the utility power supply.

In this case, each of the first switch 71, the second switch 72, the fourth switch 74, and the fifth switch 75 is closed. The utility power is inputted into the energy storage power supply 100 from the first live terminal 221, flows through the first switch 71 and the fourth switch 74, and then is transmitted to the output socket 80 of the energy storage power supply 100, providing a stable alternating current to the electrical load 300 connected to the output socket 80 of the energy storage power supply 100 to ensure normal operation of the electrical load 300. The second switch 72 and the fifth switch 75 are closed, which allows a current of the electrical load 300 flowing out from the neutral line 50 of the output socket 80 to flow back to the first neutral terminal 222, thereby forming a complete, stable, and low-impedance utility power supply circuit. Moreover, the live connection terminal 21 of the inverter 20 is connected between the second end of the first switch 71 and the first end of the fourth switch 74. A part of the utility power flowing into the energy storage power supply 100 from the first live terminal 221 is converted into a direct current by the inverter 20 to charge the battery module 10.

When the utility power fails, the first switch 71 and the second switch 72 are opened and the fourth switch 74 and the fifth switch 75 are closed. At this time, the direct current outputted by the battery module 10 of the energy storage power supply 100 is converted by the inverter 20 into an alternating current, enabling power to be supplied to the electrical load 300 connected to the output socket 80, thus satisfying the normal operation of the electrical load 300 under a condition of utility power failure and the relevant usage requirements of the user. The first end of the grounding circuit 30 is connected between the first neutral terminal 222 and the first end of the second switch 72, and the second end of the grounding circuit 30 is connected to the ground line 60. When the electrical load 300 connected to the output socket 80 is an electrical load 300 that requires grounding detection, in order to ensure normal startup and stable use of the electrical load 300, the grounding circuit 30 can be connected, i.e., the grounding switch 32 of the grounding circuit 30 is closed. In this way, in an inversion power supply mode of the battery module 10, an electrical connection is established between the neutral line 50 and the ground line 60 of the output socket 80, causing a potential difference between the neutral line 50 and the ground line 60 of the output socket 80 to approach zero. The grounding state of the utility power is simulated, which provides a correct potential reference for the grounding detection circuit, the leakage protection circuit, and the insulation monitoring circuit inside the electrical load 300, enabling the electrical load 300 to correctly identify a system grounding state. This avoids triggering protection, alarms, or failure to start due to the failure to detect effective grounding, ensuring that the electrical load 300 can still operate normally, stably, and safely when powered by the battery module 10. As a result, the relevant usage requirements of the user are further satisfied, and an application scenario of the energy storage power supply 100 is enriched.

It should be noted that, in this embodiment, closing and opening of the first switch 71 and the second switch 72 are not affected by each other, enabling connection or disconnection control on the live line 40 or the neutral line 50 to be performed independently. The fourth switch 74 and the fifth switch 75 are ganged single-pole single-throw switches that are operable synchronously to control the connection and disconnection of the circuit.

Referring to FIG. 1, in some embodiments, the live connection terminal 21 of the inverter 20 is connected between the second end of the first switch 71 and the first end of the fourth switch 74, and the neutral connection terminal 22 of the inverter 20 is connected between the second end of the second switch 72 and the first end of the fifth switch 75.

In the above embodiments, the live connection terminal 21 of the inverter 20 is disposed between the first switch 71 and the fourth switch 74, and the neutral connection terminal 22 of the inverter 20 is disposed between the second switch 72 and the fifth switch 75, ensuring that the power supply circuit has a compact structure and a reliable electrical connection.

In an exemplary embodiment of the present disclosure, the inverter 20 functions both when the utility power is available and when the utility power fails. The inverter 20 can convert the alternating current into the direct current in the rectification mode to charge the battery module 10, and convert the direct current into the alternating current in the inversion mode to supply power to the electrical load 300. When the utility power is available, the first switch 71 is closed, and the live connection terminal 21 of the inverter 20 is connected to the second end of the first switch 71. The alternating current inputted from the first live terminal 221 can be converted into a direct current under a rectification action of the inverter 20, thereby charging the battery module 10. When the utility power fails, the first switch 71 and the second switch 72 are opened, and the fourth switch 74 and the fifth switch 75 remain closed. The direct current supplied by the battery module 10 is converted by the inverter 20 into an alternating current. The alternating current is outputted from the live connection terminal 21 of the inverter 20, and flows to the second live terminal 231 through the fourth switch 74. Meanwhile, the alternating current is outputted from the neutral connection terminal 22 of the inverter 20, flows to the neutral line 50 terminal of the output socket through the fifth switch 75, providing a stable inversion power supply to the electrical load 300.

When the grounding circuit 30 is connected, the second switch 72 is closed. After flowing through the electrical load 300, the current flows back from the second neutral terminal 232. A part of the current flows to the neutral connection terminal 22 of the inverter 20 through the fifth switch 75, and another part of the current flows to the connected grounding circuit 30 through the second switch 72 and the fifth switch 75, and ultimately flows to the ground line 60. In this way, the second neutral terminal 232 and the ground line 60 are kept at approximately equipotential, to simulate a grounding condition of a utility power system. As a result, it is ensured that the electrical load 300 with functions of grounding detection, leakage protection, and insulation monitoring can operate normally.

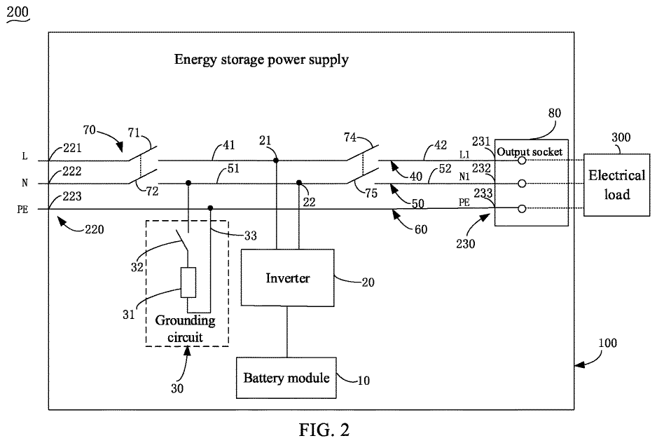

FIG. 2 is a schematic circuit diagram of an energy storage power supply 100 according to another embodiment of the present disclosure. In some embodiments, the switching switch 70 includes a first switch 71, a fourth switch 74, a second switch 72, and a fifth switch 75. The first switch 71 and the fourth switch 74 are both disposed on the live line 40, and the second switch 72 and the fifth switch 75 are both disposed on the neutral line 50. A first end of the first switch 71 is connected to the first live terminal 221, and a second end of the first switch 71 is connected to a first end of the fourth switch 74. A second end of the fourth switch 74 is connected to the output socket 80. A first end of the second switch 72 is connected to the first neutral terminal 222, and a second end of the second switch 72 is connected to a first end of the fifth switch 75. A second end of the fifth switch 75 is connected to the output socket 80. The first end of the grounding circuit 30 is connected to the second end of the second switch 72, and the second end of the grounding circuit 30 is connected to the ground line 60. When the utility power is available, each of the first switch 71, the fourth switch 74, the second switch 72, and the fifth switch 75 is closed, and the grounding circuit 30 is in an open-circuit state, enabling power to be supplied to the battery module 10 and the electrical load 300. When the utility power fails, the first switch 71 and the second switch 72 are opened, and the fourth switch 74 and the fifth switch 75 are closed, enabling the battery module 10 to supply power to the electrical load 300, and the grounding circuit 30 to be switched into a connection state.

In the above embodiments, through the control on the first switch 71, the second switch 72, the fourth switch 74, the fifth switch 75, and the grounding switch 32, the rapid switching between the utility power supply and the energy storage power supply 100 can be achieved, and the grounding circuit 30 can be flexibly controlled to satisfy the grounding detection requirements when the utility power fails.

In an exemplary embodiment of the present disclosure, the first end of the first switch 71 and the first end of the second switch 72 are connected to the first live terminal 221 and the first neutral terminal 222, respectively. The second end of the first switch 71 is connected to the fourth switch 74, and the second end of the second switch 72 is connected to the fifth switch 75. When the utility power is supplied, each of the first switch 71, the fourth switch 74, the second switch 72, and the fifth switch 75 is kept closed. The utility power flows to the second live terminal 231 of the output socket 80 through the first switch 71 and the fourth switch 74 to supply power to the electrical load 300, and flows back from the second neutral terminal 232 of the output socket 80 to the first neutral terminal 222, thereby forming a complete power supply circuit. In addition, the live connection terminal 21 of the inverter 20 is connected between the second end of the first switch 71 and the first end of the fourth switch 74. A part of the utility power flowing through the first switch 71 enters the inverter 20 from the live connection terminal 21 of the inverter 20 and is used to charge the battery module 10 under the rectification action of the inverter 20, thereby achieving energy storage of the energy storage power supply 100.

When the utility power fails, the first switch 71 and the second switch 72 are opened and the fourth switch 74 and the fifth switch 75 are closed. At this time, the direct current outputted by the battery module 10 of the energy storage power supply 100 is converted into an alternating current by the inverter 20, thereby supplying power to the electrical load 300 connected to the output socket 80. Therefore, the normal operation of the electrical load 300 under the condition of utility power failure and the relevant usage requirements of the user are satisfied.

The second switch 72 and the fifth switch 75 are disposed on the neutral line 50. The first end of the grounding circuit 30 is connected between the second end of the second switch 72 and the first end of the fifth switch 75, and the second end of the grounding circuit 30 is connected to the ground line 60. When the electrical load 300 connected to the output socket 80 is a load that requires grounding detection, in order to ensure the normal startup and stable use of the electrical load 300, the grounding circuit 30 can be connected, i.e., the grounding switch 32 of the grounding circuit 30 is closed. In this way, in the inversion power supply mode of the battery module 10, an electrical connection is established between the neutral line 50 and the ground line 60 of the output socket 80, causing the potential difference between the neutral line 50 and the ground line 60 of the output socket 80 to approach zero. The grounding state of the utility power is simulated, providing the correct potential reference for the grounding detection circuit, the leakage protection circuit, and the insulation monitoring circuit inside the electrical load 300, enabling the relevant electrical load 300 to correctly identify the system grounding state. This avoids triggering protection, alarms, or failure to start due to the failure to detect effective grounding, ensuring that the electrical load 300 can still operate normally, stably, and safely when powered by the battery module 10. As a result, the relevant usage requirements of the user are further satisfied, and the application scenario of the energy storage power supply 100 is enriched.

It should be noted that, in this embodiment, the first switch 71 and the second switch 72 are linked single-pole single-throw switches, and the fourth switch 74 and the fifth switch 75 form another set of linked single-pole single-throw switches. The first switch 71 and the second switch 72 are synchronously opened or closed to control rapid disconnection or connection of the associated circuit. When the grounding circuit 30 is connected under the condition of utility power failure, only the grounding switch 32 of the grounding circuit 30 needs to be operated, without performing a relevant operation on the switching switch 70, making the operation manner simpler and quicker.

Referring to FIG. 2, in some embodiments, the live connection terminal 21 of the inverter 20 is connected between the second end of the first switch 71 and the first end of the fourth switch 74, and the neutral connection terminal 22 of the inverter 20 is connected between the second end of the second switch 72 and the first end of the fifth switch 75.

In the above embodiments, the live connection terminal 21 of the inverter 20 is connected between the first switch 71 and the fourth switch 74, and the neutral connection terminal 22 of the inverter 20 is connected between the second switch 72 and the fifth switch 75, ensuring that the power supply circuit has a compact structure and a reliable electrical connection.

In an exemplary embodiment of the present disclosure, when the utility power is available, the first switch 71 is closed, and the live connection terminal 21 of the inverter 20 is connected to the second end of the first switch 71. The alternating current inputted from the first live terminal 221 can be converted into a direct current under the rectification action of the inverter 20, thereby charging the battery module 10. When the utility power fails, the first switch 71 and the second switch 72 are opened, and the fourth switch 74 and the fifth switch 75 remain closed. The direct current provided by the battery module 10 is converted by the inverter 20 into an alternating current. The alternating current is outputted from the live connection terminal 21 of the inverter 20 and flows to a live line 40 terminal of the output socket through the fourth switch 74. Meanwhile, the alternating current is outputted from the neutral connection terminal 22 of the inverter 20, and flows to the neutral line 50 terminal of the output socket through the fifth switch 75, providing a stable inversion power supply to the electrical load 300.

When the grounding circuit 30 is connected, the grounding switch 32 is closed. After flowing through the electrical load 300, the current flows back from the second neutral terminal 232. A part of the current flows to the neutral connection terminal 22 of the inverter 20 through the fifth switch 75, and another part of the current flows to the grounding circuit 30 through the fifth switch 75 and ultimately flows to the ground line 60. In this way, the neutral line 50 and the ground line 60 of the output socket 80 are kept at approximately equipotential, to simulate the grounding condition of the utility power system, thereby ensuring that the electrical load 300 with the functions of grounding detection, leakage protection, and insulation monitoring can operate normally.

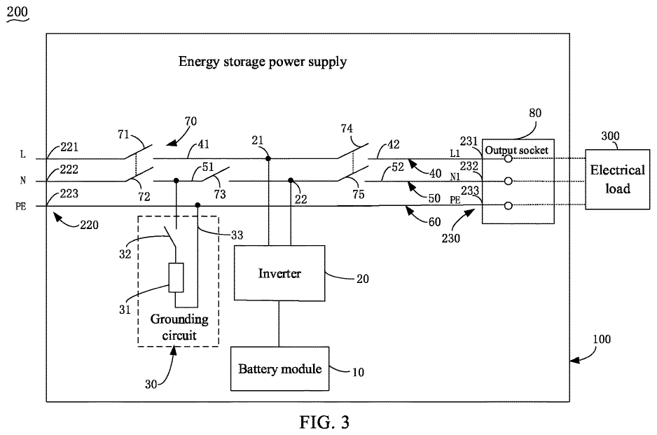

FIG. 3 is a schematic circuit diagram of an energy storage power supply 100 according to yet another embodiment of the present disclosure. In some embodiments, the switching switch further includes a third switch 73. A first end of the third switch 73 is connected to the second end of the second switch 72, and a second end of the third switch 73 is connected to the first end of the fifth switch 75. The neutral connection terminal 22 of the inverter 20 is connected between the second end of the third switch 73 and the first end of the fifth switch 75. When the utility power is available, each of the first switch 71, the fourth switch 74, the second switch 72, the fifth switch 75, and the third switch 73 is closed, and the grounding circuit 30 is in an open-circuit state, enabling power to be supplied to the battery module 10 and the electrical load 300. When the utility power fails, the first switch 71 and the second switch 72 are opened, and the fourth switch 74, the fifth switch 75, and the third switch 73 are closed, enabling the battery module 10 to supply power to the electrical load 300, and the grounding circuit 30 to be switched into a connection state.

In the above embodiments, by simultaneously controlling the close or open of the first switch 71, the fourth switch 74, the second switch 72, the fifth switch 75, and the third switch 73, the rapid switching between the utility power supply and the energy storage power supply 100 can be achieved, ensuring an uninterrupted power supply to the electrical load 300. Moreover, the grounding circuit 30 can be flexibly controlled to satisfy the grounding detection requirements when the utility power fails.

In an exemplary embodiment of the present disclosure, the difference between the embodiment in FIG. 3 and the embodiment in FIG. 2 is that the embodiment in FIG. 3 is additionally provided with a third switch 73 between the second switch 72 and the fifth switch 75, and that the first end of the grounding circuit 30 is connected between the second switch 72 and the third switch 73.

When the utility power is available, each of the first switch 71, the second switch 72, the third switch 73, the fourth switch 74, and the fifth switch 75 is closed, and the grounding circuit 30 is in the open-circuit state. The utility power flows to the output socket 80 through the first switch 71 and the fourth switch 74 to supply power to the electrical load 300, and flows from the second neutral terminal 232 of the output socket 80 to the first neutral terminal 222 through the fifth switch 75, the third switch 73, and the second switch 72, thereby forming a complete power supply circuit.

When the utility power fails, the first switch 71 and the second switch 72 are opened and the fourth switch 74 and the fifth switch 75 are closed. At this time, the electrical load 300 is powered by the energy storage power supply 100. When the electrical load 300 is the electrical load 300 that requires the grounding detection, the third switch 73 and the grounding switch 32 of the grounding circuit 30 can be manually closed directly or remotely. At this time, the neutral line 50 and the ground line 60 are connected, satisfying the grounding detection requirements of the electrical load 300, thereby enabling the energy storage power supply 100 to supply power to the corresponding electrical load 300 and satisfying the relevant usage requirements.

In addition, in the power supply mode of the energy storage power supply 100, when it is necessary to disconnect the grounding circuit 30, only one of the grounding switch 32 and the third switch 73 needs to be opened, ensuring operation quickness. Moreover, when one of the grounding switch 32 and the third switch 73 fails, the grounding circuit 30 can still be disconnected through the other one of the grounding switch 32 and the third switch 73, further ensuring smooth connection and disconnection of the grounding circuit 30.

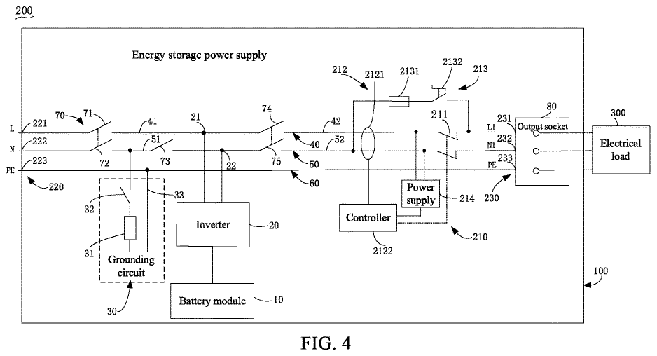

FIG. 4 is a schematic circuit diagram of an energy storage power supply 100 according to still another embodiment of the present disclosure.

Embodiments of the present disclosure further provide a power supply circuit 200. The power supply circuit 200 includes the energy storage power supply 100 according to any of the above embodiments.

In an exemplary embodiment of the present disclosure, in the power supply circuit 200 including the energy storage power supply 100 according to any of the above embodiments, when the utility power fails, the power supply circuit 200 supplies power to the electrical load 300 through the energy storage power supply 100. Under the action of the grounding circuit 30 for the energy storage power supply 100, it can be ensured that the electrical load 300 requiring the grounding detection can smoothly pass the grounding detection under the condition of utility power failure, enabling the energy storage power supply 100 to be started and operated normally. In this way, the power supply circuit 200 can supply power to the electrical load 300 requiring the grounding detection during a power failure, enriching the usage scenario of the power supply circuit 200.

Referring to FIG. 1 to FIG. 4, in some embodiments, the power supply circuit 200 further includes a leakage protection circuit 210 disposed between the output socket of the energy storage power supply 100 and the electrical load 300.

In the above embodiments, the leakage protection circuit 210 ensures electrical safety at the electrical load 300 under both conditions of available utility power and utility power failure.

In an exemplary embodiment of the present disclosure, the leakage protection circuit 210 is a safety protection circuit configured to monitor a current balance state between the live line 40 and the neutral line 50 in the power supply circuit in real time. When a current imbalance occurs due to personal electric shock, line insulation damage, or leakage of the electrical load 300, the leakage protection circuit 210 can quickly and automatically cut off the electrical connection between the utility power or the energy storage power supply 100 and the electrical load 300, to protect device safety and user's electrical safety.

For example, when a leakage from the live line 40 to a housing of the electrical load 300 occurs inside the electrical load 300, a part of the current of the live line 40 will flow back to the neutral line 50 through the ground terminal of the electrical load 300. At this time, the currents of the live line 40 and the neutral line 50 become unbalanced. The leakage protection circuit 210 quickly disconnects a circuit of the live line 40, cutting off an electrical connection between the electrical load 300 and the outside, ensuring that no current is inputted to the electrical load 300 under the leakage condition, thereby ensuring the electrical safety of the user.

Referring to FIG. 1 to FIG. 4, in some embodiments, the leakage protection circuit 210 includes a connection switch 211 and a control assembly 212. The connection switch 211 is connected between the output socket 80 and the inverter 20. The control assembly 212 is configured to control closing and opening of the connection switch 211, to connect and disconnect a circuit between the output socket 80 and the inverter 20.

In the above embodiments, a leakage protection function of the leakage protection circuit 210 is achieved by controlling the closing and opening of the connection switch 211 through the control assembly 212, ensuring rapid response of the leakage protection circuit 210.

In an exemplary embodiment of the present disclosure, the connection switch 211 is connected to the live line 40 and the neutral line 50 of the power supply circuit between the output socket 80 and the inverter 20. When the connection switch 211 is closed, an input current of the output socket 80 flows to the electrical load 300 through the live line 40 in the circuit, and the power supply circuit between the output socket 80 and the electrical load 300 operates normally. Exemplarily, the connection switch 211 is a normally closed relay. The control assembly 212 is a core control unit in the leakage protection circuit 210, and is configured to monitor a circuit current in real time, perform logical determination, and output a control signal when a leakage is detected, driving the connection switch 211 to quickly cut off the power supply circuit.

When a leakage occurs in the electrical load 300 due to conditions such as a damaged power cord or aged insulation, the control assembly 212 controls the connection switch 211 to be opened by detecting the circuit current in real time when the leakage current is greater than a predetermined threshold, to cut off the current input to the electrical load 300 and achieve real-time protection. By clearly dividing functions of the control assembly 212 and the connection switch 211, efficient and reliable operation of the leakage protection circuit 210 is achieved.

Referring to FIG. 1 to FIG. 4, in some embodiments, the control assembly 212 includes a detection unit 2121 and a controller 2122. The detection unit 2121 is disposed between the connection switch 211 and the inverter 20. The detection unit 2121 is configured to collect current signals of the live line 40 and the neutral line 50 between the inverter 20 and the electrical load 300 in real time. The controller 2122 is electrically connected to the detection unit 2121, and is configured to control the connection switch 211 to be closed based on the current signals collected by the detection unit 2121 when there is no leakage in the electrical load 300, and to control the connection switch 211 to be opened when a leakage occurs in the electrical load 300.

In the above embodiments, the detection unit 2121 achieves the balance detection of the power supply circuit between the inverter 20 and the electrical load 300. The controller 2122 is responsible for receiving a detection signal from the detection unit 2121 and controlling the closing and opening of the connection switch 211, ensuring that the leakage protection circuit 210 can operate stably, accurately, and quickly under different power supply modes, including the utility power supply mode and the power supply mode of the energy storage power supply 100.

In an exemplary embodiment of the present disclosure, the detection unit 2121 is a device configured to collect current information between the live line 40 and the neutral line 50 of the power supply circuit of the electrical load 300. Exemplarily, the detection unit 2121 is a current sensor. The detection unit 2121 can collect the current information of the live line 40 and the neutral line 50, and the controller 2122 controls the closing and opening of the connection switch 211 based on the current information collected by the detection unit 2121.

For example, when there is no leakage in the electrical load 300, the current flowing from the live line 40 to the electrical load 300 is equal in magnitude to the current flowing back from the electrical load 300 to the neutral line 50, and the currents of the live line 40 and the neutral line 50 are balanced. At this time, the controller 2122 controls the connection switch 211 to remain in a normally closed state, and the electrical load 300 operates normally. When a leakage occurs in the electrical load 300, a part of the current flowing from the live line 40 to the electrical load 300 flows to the grounding circuit through the electrical load 300. The current flowing from the live line 40 to the electrical load 300 is not equal in magnitude to the current flowing back from the electrical load 300 to the neutral line 50, resulting in a current imbalance between the live line 40 and the neutral line 50. At this time, a current difference between the live line 40 and the neutral line 50 is a leakage current magnitude of the power supply circuit. When the leakage current magnitude reaches a predetermined value, the controller 2122 controls the normally closed connection switch 211 to be opened, to cut off a live line 40 path in the power supply circuit, thereby stopping the current input to the electrical load 300. Therefore, circuit breaker protection is achieved. The leakage protection circuit 210 further includes a power supply 214. The power supply 214 is connected to the controller 2122 and the live line 40, and is configured to supply power to the controller 2122.

Referring to FIG. 1 to FIG. 4, in some embodiments, the leakage protection circuit 210 further includes an analog circuit 213 including a detection resistor 2131 and a detection switch 2132. A first end of the detection resistor 2131 is connected to the neutral line 50, and a second end of the detection resistor 2131 is connected to a first end of the detection switch 2132. A second end of the detection switch 2132 is connected to the live line 40. When the detection switch 2132 is closed, a part of the current flowing out from the output socket 80 flows to the neutral line 50 to change the current signal collected by the detection unit 2121, which is used to verify effectiveness of the control assembly 212.

In the above embodiments, the analog circuit 213 can verify effectiveness of the controller 2122 at any time, which can timely detect an associated fault to ensure long-term effective operation of the controller 2122 and protect long-term safety of the circuit. The effectiveness of the control assembly 212 can be verified at any time through the closing and opening of the detection switch, providing a simple operation method and a reliable and easily implementable detection manner.

In an exemplary embodiment of the present disclosure, the analog circuit 213 is a dedicated circuit in the leakage protection circuit 210 to simulate a leakage fault and thus verify whether a protection function of the control assembly 212 of the leakage protection circuit 210 is effective. According to the detection for leakage current and the leakage protection method of the control assembly 212, the analog circuit 213 simulates a leakage current to artificially generate a known, safe, and controllable simulated leakage current, causing the analog circuit 213 to detect an imbalance between the current flowing into the electrical load 300 from the live line 40 and the current flowing back to the neutral line 50. In this way, the controller 2122 can control the connection switch 211 to be opened based on the unbalanced current information, cutting off the current input to the electrical load 300.

The analog circuit 213 includes the resistor element 2131 and the detection switch 2132 connected in series. The first end of the resistor element 2131 is connected to the neutral line 50, and the second end of the resistor element 2131 is connected to the first end of the detection switch 2132. The second end of the detection switch 2132 is connected to the live line 40. The analog circuit 213 is connected across the live line 40 and the neutral line 50 of the power supply circuit. The resistor element 2131 can limit the simulated leakage current within a safe and standard preset range, avoiding damage to the circuit due to an excessive current, while providing a stable and standard test current to ensure a reliable leakage protection operation. The detection switch 2132 is a switch element configured to control closing and opening of the analog circuit 213 and trigger a leakage protection function verification process. The detection switch 2132 of the analog circuit 213 is a normally open switch.

When it is necessary to verify the effectiveness of the leakage protection circuit 210, the detection switch 2132 can be manually or automatically controlled to be closed. When the detection switch 2132 is closed, a part of the current originally flowing from the live line 40 in the power supply circuit to the electrical load 300 flows to the resistor element 2131 and then to the neutral line 50. At this time, the current flowing out from the live line 40 and the current flowing back from the electrical load 300 to the neutral line 50 become unbalanced. In this way, the unbalanced current information collected by the detection unit 2121 of the control assembly 212 under the leakage condition is simulated, thereby verifying the effectiveness of the control assembly 212.

In this way, by providing the analog circuit 213 on the leakage protection circuit 210, the user can perform self-inspection at any time to confirm that the leakage protection circuit 210 has not failed or been damaged, ensuring that it can operate reliably during actual leakage or electric shock, and avoiding safety hazards such as electric shock and fire due to the failure of the control assembly 212 of the leakage protection circuit 210.

In the description of this specification, descriptions with reference to the terms “an embodiment”, “some embodiments”, “schematic embodiments”, “examples”, “specific examples”, or “some examples”, etc., mean that specific features, structure, materials, or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner.

Although the embodiments of the present disclosure have been shown and described above, it can be understood by those of ordinary skill in the art that various changes, modifications, replacements, and variations can be made to these embodiments without departing from the principles and ideas of the present disclosure. The scope of the present disclosure is defined by the claims as attached and their equivalents.

What is claimed is:

1. A power supply circuit for an energy storage power supply, the power supply circuit comprising:
an alternating current input terminal configured to be supplied with an external alternating current, wherein the alternating current input terminal comprises a first live terminal, a first neutral terminal, and a first ground terminal;
an alternating current output terminal configured to output the external alternating current, wherein the alternating current output terminal comprises a second live terminal, a second neutral terminal, and a second ground terminal;
an inverter having a live connection terminal and a neutral connection terminal, wherein the live connection terminal is electrically connected to the first live terminal through a first live branch, wherein the neutral connection terminal is electrically connected to the first neutral terminal through a first neutral branch, wherein the live connection terminal is electrically connected to the second live terminal through a second live branch, and wherein the neutral connection terminal is electrically connected to the second neutral terminal through a second neutral branch; and
a grounding circuit electrically connected to the first neutral branch and the second ground terminal, wherein the grounding circuit is configured to selectively establish a short-circuit connection between the first neutral branch and the second ground terminal.

2. The power supply circuit according to claim 1, wherein the grounding circuit comprises:
a wire, wherein two ends of the wire are connected to the first neutral branch and the second ground terminal, respectively;
a resistor element connected in series between the first neutral branch and a ground line; and
a grounding switch connected between the first neutral branch and the ground line and configured to control connection and disconnection of the grounding circuit.

3. The power supply circuit according to claim 1, wherein:
the first live branch is provided with a first switch; and
the first neutral branch is provided with a second switch configured to control connection and disconnection of the alternating current input terminal for inputting the alternating current.

4. The power supply circuit according to claim 3, wherein the grounding circuit is electrically connected to the first neutral branch between the second switch and the neutral connection terminal.

5. The power supply circuit according to claim 3, wherein the grounding circuit is electrically connected to the first neutral branch between the second switch and the first neutral terminal.

6. The power supply circuit according to claim 4, wherein the first neutral branch is further provided with a third switch disposed closer to the neutral connection terminal than the second switch,
wherein the grounding circuit is electrically connected to the first neutral branch between the second switch and the third switch.

7. The power supply circuit according to claim 4, wherein:
the second live branch is provided with a fourth switch; and
the second neutral branch is provided with a fifth switch, wherein:
a first end of the first switch is connected to the first live terminal, a second end of the first switch is connected to a first end of the fourth switch, and a second end of the fourth switch is connected to an output socket;
a second end of the second switch is connected to a first end of the fifth switch, and a second end of the fifth switch is connected to the output socket, wherein:
when utility power is available, each of the first switch, the second switch, the fourth switch, and the fifth switch is closed, and the grounding circuit is in an open-circuit state, enabling power to be supplied to an electrical load; and
when the utility power fails, the first switch and the second switch are opened, and the fourth switch and the fifth switch are closed, enabling the energy storage power supply to supply power to the electrical load and the grounding circuit to be switched into a connection state.

8. The power supply circuit according to claim 7, wherein:
the live connection terminal of the inverter is connected between the second end of the first switch and the first end of the fourth switch; and
the neutral connection terminal of the inverter is connected between the second end of the second switch and the first end of the fifth switch.

9. The power supply circuit according to claim 5, wherein:
the second live branch is provided with a fourth switch; and
the second neutral branch is provided with a fifth switch, wherein:
a first end of the first switch is connected to the first live terminal, a second end of the first switch is connected to a first end of the fourth switch, and a second end of the fourth switch is connected to an output socket;
a first end of the second switch is connected to the first neutral terminal, a second end of the second switch is connected to a first end of the fifth switch, and a second end of the fifth switch is connected to the output socket, wherein:
when utility power is available, each of the first switch, the second switch, the fourth switch, and the fifth switch is closed, and the grounding circuit is in an open-circuit state, enabling power to be supplied to an electrical load; and
when the utility power fails, the first switch and the second switch are opened, and the fourth switch and the fifth switch are closed, enabling the energy storage power supply to supply power to the electrical load and the grounding circuit to be switched into a connection state.

10. The power supply circuit according to claim 9, wherein:
the live connection terminal of the inverter is connected between the second end of the first switch and the first end of the fourth switch; and
the neutral connection terminal of the inverter is connected between the second end of the second switch and the first end of the fifth switch.

11. The power supply circuit according to claim 6, wherein:
the second live branch is provided with a fourth switch; and
the second neutral branch is provided with a fifth switch, wherein:
a first end of the third switch is connected to a second end of the second switch, and a second end of the third switch is connected to a first end of the fifth switch; and
the neutral connection terminal of the inverter is connected between the second end of the third switch and the first end of the fifth switch, wherein:
when utility power is available, each of the first switch, the second switch, the third switch, the fourth switch, and the fifth switch is closed, and the grounding circuit is in an open-circuit state, enabling power to be supplied to an electrical load; and
when the utility power fails, the first switch and the second switch are opened, and the third switch, the fourth switch, and the fifth switch are closed, enabling the energy storage power supply to supply power to the electrical load and the grounding circuit to be switched into a connection state.

12. The power supply circuit according to claim 11, wherein:
the live connection terminal of the inverter is connected between a second end of the first switch and a first end of the fourth switch; and
the neutral connection terminal of the inverter is connected between the second end of the third switch and the first end of the fifth switch.

13. The power supply circuit according to claim 3, wherein:
the second live branch is provided with a fourth switch;
the second neutral branch is provided with a fifth switch; and
the power supply circuit further comprises a detection unit configured to detect a current of the second live branch and a current of the second neutral branch,
wherein when a difference between the current of the second live branch and the current of the second neutral branch is greater than a predetermined threshold, the fourth switch and the fifth switch are opened or the inverter stops operating.

14. The power supply circuit according to claim 13, further comprising an analog circuit comprising a detection resistor and a detection switch, wherein:
a first end of the detection resistor is connected to the second neutral branch, a second end of the detection resistor is connected to a first end of the detection switch, and a second end of the detection switch is connected to the second live branch,
wherein when the detection switch is closed, the current of the second live branch is partially shunted to the analog circuit, enabling the difference between the current of the second live branch and the current of the second neutral branch to be greater than the predetermined threshold to verify effectiveness of the detection unit.

15. An energy storage power supply, comprising:
the power supply circuit according to claim 1; and
a battery module electrically connected to the inverter.

16. The energy storage power supply according to claim 15, wherein the grounding circuit comprises:
a wire, wherein two ends of the wire are connected to the first neutral branch and the second ground terminal, respectively;
a resistor element connected in series between the first neutral branch and a ground line; and
a grounding switch connected between the first neutral branch and the ground line and configured to control connection and disconnection of the grounding circuit.

17. The energy storage power supply according to claim 15, wherein:
the first live branch is provided with a first switch; and
the first neutral branch is provided with a second switch configured to control connection and disconnection of the alternating current input terminal for inputting the alternating current.

18. The energy storage power supply according to claim 17, wherein the grounding circuit is electrically connected to the first neutral branch between the second switch and the neutral connection terminal.

19. The energy storage power supply according to claim 17, wherein the grounding circuit is electrically connected to the first neutral branch between the second switch and the first neutral terminal.

20. The energy storage power supply according to claim 18, wherein the first neutral branch is further provided with a third switch disposed closer to the neutral connection terminal than the second switch,
wherein the grounding circuit is electrically connected to the first neutral branch between the second switch and the third switch.
